(19) United States
(12) Patent Application Publication
(10) Pub. No.: US 2008/0168777 A1
(43) Pub. Date: Jul. 17, 2008

(54) Cryostat for Transporting Cooled Equipment at a Cryogenic Temperature

(75) Inventors: Andrew Farquhar ATKINS, Oxon (GB); Marcel Jan Marie KRUIP, Oxford (GB)

Correspondence Address: CROWELL & MORING LLP;INTELLECTUAL PROPERTY GROUP, P.O. BOX 14300, WASHINGTON, DC, 20044-4300, US

(73) Assignee: Siemens Magnet Technology Ltd., Oxon (GB)

(21) Appl. No.: 11/956,933

(22) Filed: Dec. 14, 2007

(30) Foreign Application Priority Data
Jan. 11, 2007 (GB) 0700516.8

(51) Int. Cl. F17C 1/00

(52) U.S. Cl. 62/51.1; 62/62

(57) ABSTRACT

A cryostat for transporting cooled equipment at an upper cryogenic temperature, the cryostat being arranged to cool the cooled equipment by a working cryogen which boils at a lower cryogenic temperature, comprising a vacuum container surrounding the cooled equipment and defining a nominally evacuated layer between the vacuum container and the cooled equipment. Means are provided to reduce contamination of the nominally evacuated layer by a vacuum contaminant which is present in gaseous form within the evacuated layer at the upper cryogenic temperature, but which is retained in liquid or solid form at the lower cryogenic temperature.

As is well known in the art, it is typical to transport cryogenically cooled apparatus such as superconducting magnet structures for magnetic resonance imaging (MRI) systems in a cryostat at least partially filled with a working cryogen. During transport, the cryogen boils, holding the cooled apparatus at the boiling point of the working cryogen.

During transport, the rate of warming of the cooled apparatus depends on the heat flux into the apparatus. This in turn is determined by three main sources. Firstly, radiant heat is emitted from relatively warm surfaces onto cooler neighbouring surfaces. A typical example of this will be a relatively warm outer vacuum chamber radiating heat to a cryogen vessel containing the cooled equipment. Secondly, heat may be conducted through mechanical support structures which hold the cooled equipment in place, or which hold a cryogen vessel in place within an outer vacuum chamber. Thirdly, convective heat flow may occur by convection of residual vacuum contaminant gases trapped in nominally evacuated layers between relatively warm and relatively cool surfaces, for example between a cryogen vessel and an outer vacuum container of a cryostat. The radiant and conductive heat flows into the cooled apparatus are both strongly dependent on the temperature differentials between various parts of the cryostat, with the dependency also affected by the structure of the cryostat. On the other hand, the convective heat influx is not simply related to the temperature or the temperature differentials of the various parts of the cryostat. This is because the quality of the vacuum—the proportion of residual vacuum contaminant gases—in a nominally evacuated layer is not constant with temperature. In normal operation, the cryostat will be held at its operating temperature, the boiling point of the working cryogen, by boiling of the working cryogen. Vacuum contaminants freeze on to the coldest parts of the cryostat—typically the cryogen vessel containing the cooled apparatus, or cooling tubes arranged in contact with the cooled equipment and containing a liquid cryogen. A good-quality, or ‘hard’, vacuum is maintained by the low temperature which holds vacuum contaminants in solid form.

However, during transport, the cryostat is initially held at the temperature of the boiling point of the working cryogen, by boiling of the working cryogen. However, the cryostat will warm up once the working cryogen has boiled off. Some of the frozen vacuum contaminants will return to a gaseous state, degrading the quality of the vacuum. At the boiling point of each contaminant, a sharp increase in convective heat influx is observed.

In a particular situation addressed by the present invention, a cooled equipment is maintained at working temperature by liquid helium. A quantity of liquid helium is provided in the cryostat to hold the apparatus at operating temperature for a certain period of time, by boiling of the helium. Should the liquid helium boil dry during transport, the apparatus will heat up during transport. On arrival, the equipment will need to be cooled back to liquid helium temperature (about 4 K). This will typically require the consumption of a certain volume of helium, which may be considerable if the system has heated to ambient temperature (about 290 K).

Hydrogen boils at about 20 K. As the cryostat warms from 4 K, any solidified hydrogen in a nominally evacuated layer will evaporate at about 20 K, and will enable thermal convection currents to be established within the nominally evacuated layer, increasing convective heat influx to the cooled equipment.

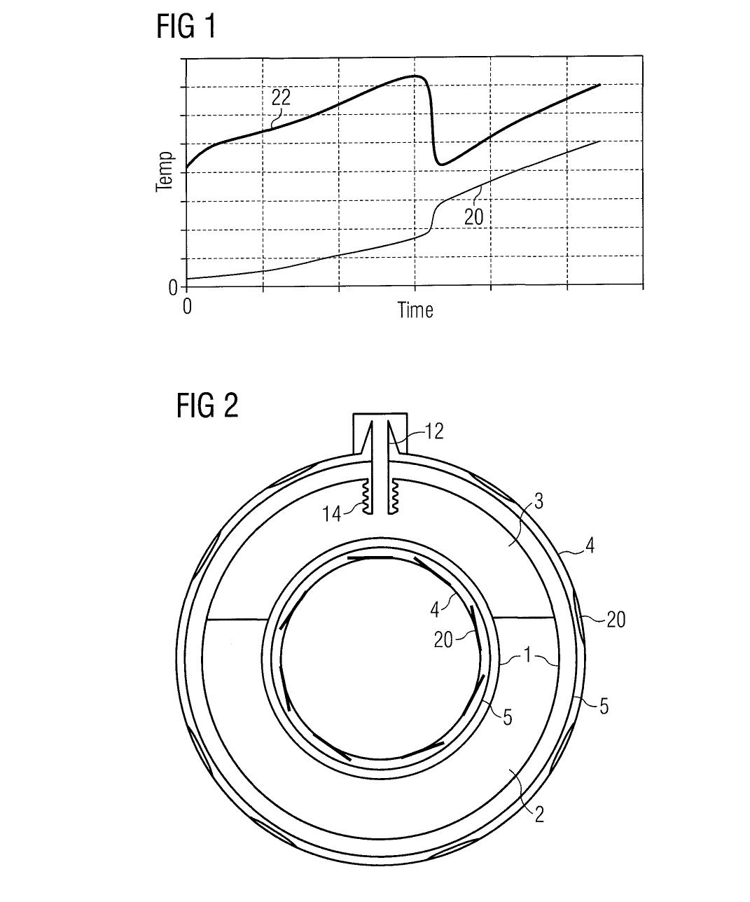

FIG. 1 illustrates experimental results of warming of a cooled equipment, beginning at the instant that a helium working cryogen boils dry. Curve 20 indicates the temperature of the cooled equipment. In this example, a thermal shield is provided in the nominally evacuated space. The temperature of the shield is shown as curve 22. As can be seen, the temperature 20 of the cooled equipment rises at a first steady rate, defined by radiation and conduction heat influx. As the temperature rises to the boiling point of the vacuum contaminant with the lowest boiling point—typically hydrogen at about 20 K—a sharp rise in the rate of temperature increase occurs. The rate of temperature rise then settles to a second steady rate, faster than the first steady rate, defined by radiation, conduction and convection heat influx. The temperature 22 of the shield initially rises at a first steady rate, defined by radiation and conduction heat influx. As the temperature rises to the boiling point of the vacuum contaminant with the lowest boiling point—typically hydrogen at about 20K—a sharp drop in actual temperature occurs, followed by a temperature rise at a second steady rate, faster than the first steady rate, defined by radiation, conduction and convection heat influx. The sharp fall in temperature of the shield is caused by the onset of convection currents which cool the shield by transfer of heat to the cryogen vessel.

The present invention aims to eliminate or at least reduce the transition to a higher rate of heat influx, by reducing the convection effect of vacuum contaminants within the thermal insulation vacuum layer. This is achieved by the methods and apparatus as recited in the appended claims.

The above, and further, objects, characteristics and advantages of the present invention will become more apparent from consideration of the following description of certain embodiments thereof, in conjunction with the accompanying drawings, wherein:

FIG. 1 illustrates the typical temperature variation of a cryogenically cooled system once a cooling inventory of working cryogen has boiled dry; and

FIG. 2 illustrates a conventional cryostat, modified according to an embodiment of the present invention.

While many known cryogenically cooled equipment, such as magnets for Magnetic Resonance Imaging (MRI) systems, are operated at liquid helium temperatures (about 4 K), it is difficult and expensive to transport such systems at liquid helium temperatures, due to the cost and limited availability of liquid helium. As a result, the cooled equipment may be provided with only a limited quantity of liquid helium for transport, which may be exhausted before the cooled equipment reaches its destination. The cooled equipment may then begin to warm up due to heat influx, as described above.

As discussed above, the insulating effect of a vacuum insulating layer is degraded by the presence of vacuum contaminants. A number of these contaminants are solid at liquid helium temperatures, but evaporate when the equipment warms up. In turn, this means that heat influx into the cooled equipment increases rapidly at the boiling point of the vacuum contaminant. A typical such vacuum contaminant is hydrogen, which boils at about 20 K. The resultant increased heat influx effectively reduces the time available for transport of the cooled equipment unless a large quantity of cryogen, or a long period of mechanical cooling, is to be expended at the destination.

The present invention aims to reduce the effect of vacuum contaminants by preventing them from evaporating into the insulating vacuum space, thereby improving the quality of the insulating vacuum, reducing the rate of heat influx at the temperature at which the apparatus is transported, and so increasing the available transport time.

FIG. 2 illustrates a conventional cryostat, as used for housing a magnet for an MRI system. A cryogen vessel 1 is partially filled with a liquid cryogen 2. An outer vacuum container 4 surrounds the cryogen vessel, and defines a vacuum layer between the two vessels. The vacuum layer is evacuated to provide insulation against thermal conduction and convection. A thermal shield 5 may be placed within the vacuum layer, to protect the cryogen vessel 1 from thermal radiation from the outer vacuum container. During transport of the cryostat, the cryogen 2 will boil off into the upper part 3 of the cryogen vessel, and will escape through the neck tube arrangement 12, 14. When a helium cryogen 2 is boiling, the cryogen vessel is cooled to such a low temperature that most vacuum contaminants, including hydrogen, will solidify onto the surface of the cryogen vessel as a frost. In their solid state, such contaminants do not degrade the quality of the vacuum, and little if any heat enters the cryogen vessel as a result of thermal convection within the vacuum space.

The cryostats particularly addressed by the present invention have limited reserves of working cryogen, typically helium, which maintain the temperature of their boiling point for a limited duration. When the store of working cryogen boils dry, the cryostat heats up due to heat influx by conduction and radiation. During this rise in temperature, some of the solidified vacuum contaminants, typically hydrogen, evaporate into the vacuum layer, and cause further heat influx to the cryogen vessel by thermal convection.

According to the present invention, pieces of a getter material 20 are placed within the vacuum layer. This getter material has the property that is retains molecules of a target material. In this case, the target material is a vacuum contaminant which resides within the vacuum layer.

In the case of hydrogen, a known, effective and commercially available getter material is provided in a thin “foil” format, and is composed of an aluminium carrier sheet, which for the present invention is preferably adhesive-backed, coated with a titanium-vanadium alloy, overlain with a palladium layer. The titanium-vanadium alloy is the active getter material, while the palladium layer acts as a hydrogen-specific filter. The foil format is found to be relatively inexpensive. An appropriate getter material, developed for semiconductor outgassing, is marketed under the REL-Hy™ brand by SAES getters (www.saesgetters.com).

SAES getters also produce a material known as LOTHAR™, which adsorbs hydrogen from the evacuated jacket of cryogen pipes, dewars and tanks for liquid oxygen. This material is provided in order to achieve a hard vacuum in apparatus which operates at temperatures above the boiling point of hydrogen, such that it is essential to remove hydrogen from the vacuum space in order to have an effective vacuum jacket and avoid convective heating in an operational state due to the presence of hydrogen in the vacuum jacket.

The present invention addresses a rather different problem. The vacuum jackets addressed by the present invention operate at temperatures significantly below the boiling (or sublimation) point of hydrogen. Getters are provided not to enable a hard vacuum in the equipment during operation—that is ensured by the very low temperature of the working cryogen. Rather, the present invention addresses a method of transporting equipment at a higher temperature than its operating temperature, wherein the getters are required to ensure a sufficiently hard vacuum is provided during this relatively high-temperature transport period. Once the equipment addressed by the present invention is brought into operation, the equipment returns to the temperature of the working cryogen, and the vacuum contaminants freeze, removing the source of convective heating.

When a vacuum contaminant, such as hydrogen, is in its gaseous phase, such as before the cryogen vessel 1 has been filled with working cryogen, the molecules of contaminant move randomly through the vacuum layer. At some point, it is likely that each molecule will come into contact with the getter material. The getter material will trap at least some of the molecules which come into contact with it. Once the contaminant molecules are trapped by the getter material, they can no longer participate in thermal convection currents, and the increase in heat influx rate at and above the boiling (or sublimation) point of the contaminant is eliminated, or at least reduced.

In a certain embodiment of the present invention, adhesive-backed strips of getter material, each approximately 7 cm×15 cm were stuck onto the inner surface of the vacuum container 4 before the cryostat was assembled. By distributing these strips approximately evenly about the inner surface of the vacuum container 4, the mean path for the hydrogen molecules to the getter material is minimised. By minimising the mean path to the getter material, the required density differential for the getter to trap a contaminant molecule is reduced.

If it is required to extract only molecules of a target gas, the getter material must be coated with an appropriate filter material. In the example discussed above, a layer of palladium is employed as a hydrogen-specific filter. Other filter layers may be used to produce getter materials which are specific to other gases. In the case of gases (such as hydrogen) which are found naturally in low concentrations in the atmosphere, the filter layer overlying the active getter material increases the available handling time, the time before the getter material becomes so full of molecules from the air that is it no longer useful to place within the vacuum layer of the cryostat.

The discussed planar “foil” format enables easy installation and easy distribution within the vacuum layer. The pieces of getter material may be placed on the inner surface of the vacuum vessel 4. Alternatively, or in addition, pieces of getter material may be placed on the outer surface of the cryogen vessel 1. Alternatively, or in addition, pieces of getter material may be placed on a surface of any thermal shield 5 provided within the vacuum layer.

Since at least some of the vacuum contaminant molecules are trapped by the getter material, the effect of thermal convection in the vacuum layer is at least reduced. This in turn reduces the thermal influx to the cryogen vessel, reducing the rate of boil off of the sacrificial cryogen and increasing the transport time available.

The outer vacuum container is typically constructed of stainless steel. Hydrogen is used in the annealing of steel, resulting in hydrogen being given off by the steel later on, for example when subjected to extreme vacuum such as employed in the vacuum insulation layer of cryostats such as addressed by the present invention.

While the present invention has been discussed with reference to cryostat housing cooled equipment within a bath of working cryogen, the present invention is also applicable to arrangements where cooled equipment is cooled by a cooling loop arrangement: a thermally conductive tube in thermal contact with the equipment to be cooled, and carrying a relatively small quantity of working cryogen.

While the present invention provides an improvement to the quality of the vacuum in the vacuum layer, it is no substitute for effective initial evacuation.

The present invention has been particularly described with reference to a hydrogen vacuum contaminant. However, the present invention may also be applied to other vacuum contaminants. Hydrogen is particularly relevant, however, since its boiling point lies between the boiling points of helium and nitrogen, which are presently commonly used cryogens. While the present invention has been particularly described in relation to hydrogen contaminants in a vacuum chamber cooled by a helium working cryogen, the present invention may be applied to cryogenic cooling systems using other cryogens, in order to overcome difficulties with different contaminants.

The invention may also be applied to a cryostat cooled by a working cryogen which boils at a first temperature and further retained at a cryogenic temperature by a sacrificial cryogen which boils at a second temperature, higher than the first temperature, such systems being susceptible to thermal influx by convection due to the presence of a vacuum contaminant gas within the evacuated layer at the second temperature, but which contaminant is retained in liquid or solid form at the first temperature. In this context, the present invention may usefully be applied to cryostats employing a quantity of nitrogen, initially cooled to the temperature of a working cryogen of lower boiling point, such as helium, in which the nitrogen is provided to increase the overall heat capacity at low temperatures.

1. A cryostat for transporting cooled equipment at an upper cryogenic temperature, the cryostat being arranged to cool the cooled equipment by a working cryogen which boils at a lower cryogenic temperature, comprising a vacuum container surrounding the cooled equipment and defining a nominally evacuated layer between the vacuum container and the cooled equipment, characterized in that a getter material is placed within the nominally evacuated layer, so as to absorb molecules of a vacuum contaminant which is present in gaseous form within the evacuated layer at the upper cryogenic temperature, but which is retained in liquid or solid form at the lower cryogenic temperature.

2. A cryostat according to claim 1, further comprising a cryogen vessel housing the cooled equipment.

3. A cryostat according to claim 1 wherein the cooled equipment is cooled by a cooling loop arrangement.

4. A cryostat according to claim 1, wherein the getter material is in the form of a flat foil.

5. A cryostat according to claim 1, wherein the getter material is attached to an inner surface of the vacuum container.

6. A cryostat according to claim 2, wherein the getter material is attached to an outer surface of the cryogen vessel.

7. A cryostat according to claim 1, wherein the getter material is attached to a thermal shield located within the nominally evacuated layer.

8. A method for transporting cryogenically cooled equipment at an upper cryogenic temperature, comprising the steps of:
providing a vacuum container housing the cooled equipment and defining a nominally evacuated layer around the cooled equipment;
providing a supply of working cryogen in thermal contact with the cooled apparatus, such that the working cryogen may boil and hold the cooled apparatus at a lower cryogenic temperature, being the boiling point of the working cryogen;
characterized in that the method further comprises providing a getter material within the vacuum layer, such that molecules of vacuum contaminant gas which are present within the nominally evacuated layer at the upper cryogenic temperature, but which are retained in liquid or solid form at the lower cryogenic temperature, are trapped in the getter material.

9. A method according to claim 8 wherein the getter material is selective to a contaminant gas having a boiling or sublimation point between the lower cryogenic temperature and the upper cryogenic temperature.

10.-11. (canceled)

12. Use of a getter material to improve the quality of an insulating vacuum region surrounding a cryogen vessel in the event of the cryogen boiling dry, the getter material being inoperative while liquid cryogen is present, the cryogen being such as to boil at a lower temperature than a temperature at which the vacuum contaminant enters a gaseous phase.

13. Use of a getter material in transporting equipment cryogenically cooled by a boiling liquid cryogen, to improve the quality of an insulating vacuum region surrounding the cryogenically cooled equipment once the liquid cryogen has boiled dry, the getter material being inoperative while liquid cryogen is present, the cryogen being such as to boil at a lower temperature than a temperature at which the vacuum contaminant enters a gaseous phase.
